(19) United States
(12) Patent Application Publication
(10) Pub. No.: US 2012/0123574 A1
(43) Pub. Date: May 17, 2012

(54) Plating method of substrate and manufacturing method of circuit board using the same

(75) Inventors: Jeong-Ho Moon, Suwon-si (KR); Kwang-Ok Jeong, Gwangmyeong-si (KR); Hyo-Seung Nam, Hwaseong-si (KR)

(73) Assignee: SAMSUNG ELECTRO-MECHANICS CO., LTD., Suwon (KR)

(21) Appl. No.: 13/137,704

(22) Filed: Sep. 6, 2011

(30) Foreign Application Priority Data
Sep. 6, 2010 (KR) 10-2010-0086999

(51) Int. Cl. G06F 17/00

(52) U.S. Cl. 700/97

(57) ABSTRACT

A method of plating a substrate and a method of manufacturing a circuit board using the method of plating a substrate. The method of manufacturing a circuit board may include: providing a panel substrate, the panel substrate divided into a circuit board area and a dummy area; calculating a ratio of an area of a circuit pattern to be formed by plating in the circuit board area; determining a ratio of an area being plated in the dummy area by considering the ratio of the area being plated in the circuit board area; setting a plating part in the circuit board area and the dummy area; and forming the circuit pattern by electroplating the panel substrate. Accordingly, deviation in thickness of plating between circuit patterns can be improved.

### CROSS-REFERENCE TO RELATED APPLICATIONS

This application claims the benefit of Korean Patent Application No. 10-2010-0086999, filed with the Korean Intellectual Property Office on Sep. 6, 2010, the disclosure of which is incorporated herein by reference in its entirety.

### BACKGROUND

1. Technical Field

The present invention relates to a method of plating a substrate and a method of manufacturing a circuit board using the method of plating a substrate.

2. Background Art

In manufacturing process of a circuit board, it is common that a panel substrate, in which unit substrates, referred to as strips, are gathered, is used in order to manufacture a multiple number of substrates at the same time.

However, depending on the arrangement of the unit substrates in the panel substrate, deviations of plating occur among the unit substrates. Particularly, the unit substrates arranged along the outlines of the panel substrate are affected by adjacent dummies during the plating, making them more vulnerable to the plating deviation than other unit substrates.

### SUMMARY

The present invention provides a plating method of s substrate and a manufacturing method of a circuit board using the plating method that can minimize plating deviation caused by dummies.

An aspect of the present invention features a method of manufacturing a circuit board, which can include: providing a panel substrate, the panel substrate divided into a circuit board area and a dummy area; calculating a ratio of an area of a circuit pattern to be formed by plating in the circuit board area; determining a ratio of an area being plated in the dummy area by considering the ratio of the area being plated in the circuit board area; setting a plating part in the circuit board area and the dummy area; and forming the circuit pattern by electroplating the panel substrate.

The setting of the plating part can include stacking a plating resist on the panel substrate, the plating resist selectively exposing a portion of the circuit board area and a portion of the dummy area to be plated.

Prior to the stacking of the plating resist, a seed layer can be formed on the panel substrate.

In the determining of the ratio of the area being plated in the dummy area, the ratio of the area being plated in the dummy area can be set to 95% with respect to the ratio of the area being plated in the circuit board area.

Another aspect of the present invention features a method of plating a substrate, which can include: providing a panel substrate, the panel substrate divided into a substrate area and a dummy area; calculating a ratio of an area to be plated in the substrate area; determining a ratio of an area being plated in the dummy area by considering the ratio of the area being plated in the substrate area; setting a plating part in the substrate area and the dummy area; and electroplating the panel substrate.

A circuit pattern can be formed in the substrate area, and in the calculating of the ratio of the area to be plated in the substrate area, an area of the circuit pattern to be formed in the substrate area can be calculated.

The setting of the plating part can include stacking a plating resist on the panel substrate, the plating resist selectively exposing a portion of the substrate area and a portion of the dummy area to be plated.

Prior to the stacking of the plating resist, a seed layer can be formed on the panel substrate.

In the determining of the ratio of the area being plated in the dummy area, the ratio of the area being plated in the dummy area can be set to 95% with respect to the ratio of the area being plated in the substrate area.

### BRIEF DESCRIPTION OF THE DRAWINGS

FIG. 1 is a flow diagram illustrating a manufacturing method of a circuit board in accordance with an embodiment of the present invention.

FIG. 2 illustrates a panel substrate in the manufacturing method of a substrate in accordance with an embodiment of the present invention.

FIG. 3 illustrates setting a plating part in the manufacturing method of a substrate in accordance with an embodiment of the present invention.

FIGS. 4 and 5 illustrate deviation of plating based on a ratio of areas plated in dummy areas in accordance with an embodiment of the present invention.

### DETAILED DESCRIPTION

Hereinafter, an embodiment of the present invention will be described in detail with reference to the accompanying drawings.

FIG. 1 is a flow diagram illustrating a manufacturing method of a circuit board in accordance with an embodiment of the present invention.

The manufacturing method of a circuit board in accordance with an embodiment of the present invention includes: providing a panel substrate (S110); calculating a ratio of areas in circuit board areas (S120); determining a ratio of areas in dummy areas (S130); setting a plating part (S140); and forming a circuit pattern (S150). Through the above steps, deviation in thickness of plating can be minimized by adjusting a ratio of plated areas in dummy areas 20 with respect to a ratio of plated areas in circuit board areas during the plating.

In the step of providing a panel substrate (S110), a panel substrate 5 that is divided into circuit board areas 10 and dummy areas 20 is provided.

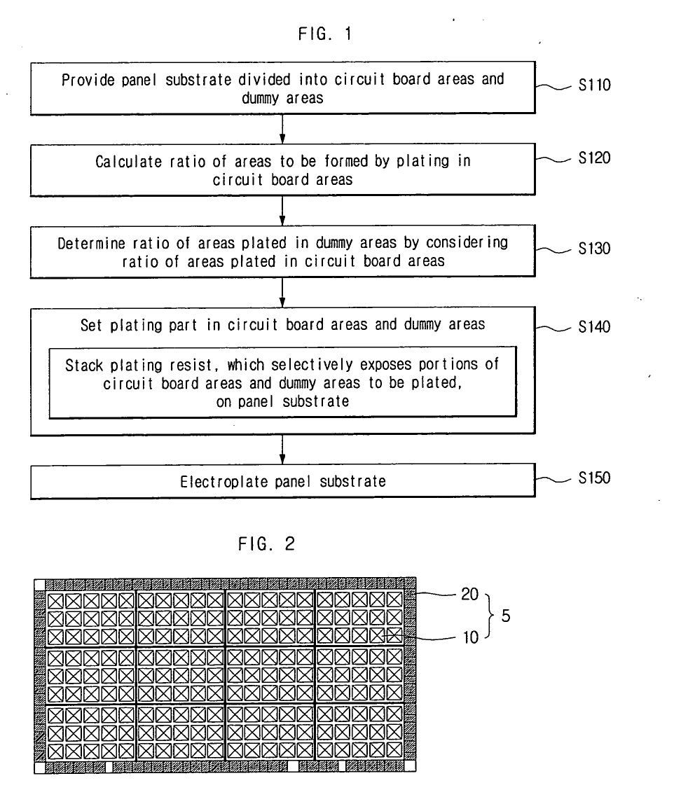

FIG. 2 illustrates a panel substrate in the manufacturing method of a substrate in accordance with an embodiment of the present invention.

As illustrated in FIG. 2, the present embodiment presents the panel substrate 5 constituted with a plurality of circuit board areas 10, which are distributed in a matrix form, and dummy areas 20, which surround the plurality of circuit board areas 10.

In the step of calculating a ratio of areas in circuit board areas (S120), the ratio of areas of the circuit pattern to be formed by plating among the circuit board areas 10 in the step of forming the circuit pattern (S150), which will be described later, is calculated. That is, the ratio of areas occupied by portions to be plated among the circuit board areas 10 is calculated.

Next, in the step of determining a ratio of areas in dummy areas (S130), the ratio of areas that are plated in the dummy areas 20 is determined by considering the ratio of areas being plated in the circuit board areas 10.

The plating quality of the circuit board areas 10 in the outlines of the panel substrate 5 is greatly affected by the dummy areas 20. A number of repeated tests confirmed that the relation between the ratio of areas being plated in the dummy areas 20 and the ratio of areas being plated in the circuit board areas 10 is important for the deviation in plating thickness of the circuit board areas 10.

Accordingly, by adjusting the ratio of areas being plated in the dummy areas 20 with respect to the ratio of areas being plated in the circuit board areas 10, the deviation in plating thickness can be minimized.

In the present embodiment, the ratio of areas being plated in the dummy areas 20 is set to 95% with respect to the ratio of areas being plated in the circuit board areas 10.

In the step of setting a plating part (S140), the plating part is set in the circuit board areas 10 and the dummy areas 20. That is, the areas to be plated in the dummy areas 20, for which the ratio of areas is determined, can be selectively plated during the plating, which will be described later, together with the portions of the circuit board areas 10, for which the circuit pattern is to be formed.

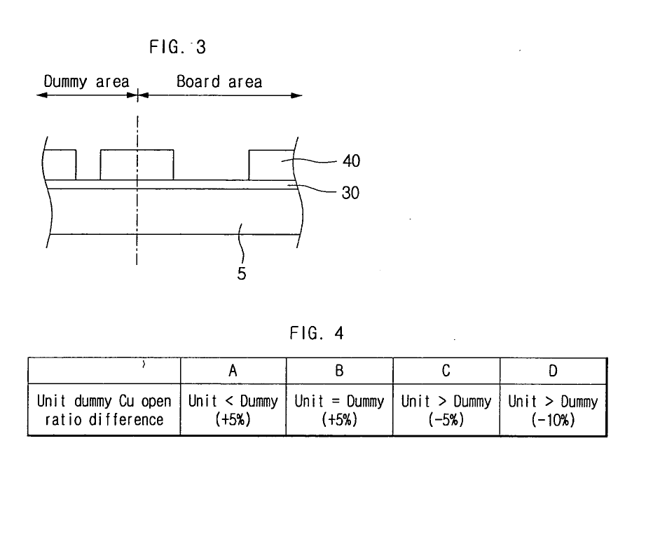

FIG. 3 illustrates setting the plating part in the manufacturing method of a substrate in accordance with an embodiment of the present invention.

As illustrated in FIG. 3, in the present embodiment, the plating part, which is selectively plated, is formed by stacking a plating resist 40, which selectively exposes portions of the circuit board areas 10 and the dummy areas 20 to be plated, on the panel substrate 5.

Here, by forming a seed layer 30 on the panel substrate 5, the panel substrate 5 can be used as an electrode in an electroplating process. Moreover, the seed layer 30 can be removed by, for example, flash etching, after the plating.

In the step of forming the circuit pattern (S150), the circuit pattern is formed by electroplating the panel substrate 5. As described above, since in the present embodiment the ratio of areas being plated in the plating part is already determined in the dummy areas 20 in accordance with the ratio of areas being plated in the circuit board areas 10, deviation of plating caused by the dummy areas 20 in the circuit pattern areas 10 that are arranged in the outlines of the panel substrate 5 can be also minimized. Therefore, the deviation of plating between manufactured circuit boards can be improved.

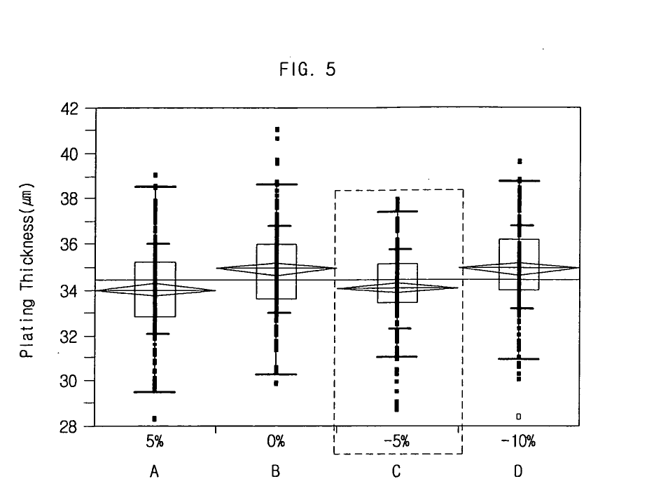

FIGS. 4 and 5 illustrate deviation of plating based on the ratio of areas plated in the dummy areas 20 in accordance with an embodiment of the present invention.

As shown in FIGS. 4 and 5, upon testing by adjusting the ratio of areas being plated in the dummy areas 20 with respect to the ratio of areas being plated in the circuit board areas 10, it was confirmed that, as in the present embodiment, the deviation in plating thickness was minimized when the ratio of areas being plated in the dummy areas 20 is set to 95% with respect to the ratio of areas being plated in the circuit board areas 10.

While the present embodiment has been described for the case of plating for forming a circuit pattern, the plating method of the present invention can be also used when objects other than a circuit pattern are to be formed on a substrate.

Although some embodiment of the present invention has been described above, it shall be appreciated that there can be a variety of permutations and modifications of the present invention by those who are ordinarily skilled in the art to which the present invention pertains without departing from the technical ideas and scope of the present invention, which shall be defined by the appended claims.

It shall be also appreciated that many embodiments other than the embodiment described above are present in the claims of the present invention.

What is claimed is:

1. A method of manufacturing a circuit board, the method comprising:
providing a panel substrate, the panel substrate divided into a circuit board area and a dummy area;
calculating a ratio of an area of a circuit pattern to be formed by plating in the circuit board area;
determining a ratio of an area being plated in the dummy area by considering the ratio of the area being plated in the circuit board area;
setting a plating part in the circuit board area and the dummy area; and
forming the circuit pattern by electroplating the panel substrate.

2. The method according to claim 1, wherein the setting of the plating part comprises stacking a plating resist on the panel substrate, the plating resist selectively exposing a portion of the circuit board area and a portion of the dummy area to be plated.

3. The method according to claim 2, further comprising, prior to the stacking of the plating resist, forming a seed layer on the panel substrate.

4. The method according to claim 1, wherein in the determining of the ratio of the area being plated in the dummy area, the ratio of the area being plated in the dummy area is set to 95% with respect to the ratio of the area being plated in the circuit board area.

5. A method of plating a substrate, the method comprising:
providing a panel substrate, the panel substrate divided into a substrate area and a dummy area;
calculating a ratio of an area to be plated in the substrate area;
determining a ratio of an area being plated in the dummy area by considering the ratio of the area being plated in the substrate area;
setting a plating part in the substrate area and the dummy area; and
electroplating the panel substrate.

6. The method according to claim 5, wherein a circuit pattern is formed in the substrate area, and
wherein, in the calculating of the ratio of the area to be plated in the substrate area, an area of the circuit pattern to be formed in the substrate area is calculated.

7. The method according to claim 5, wherein the setting of the plating part comprises stacking a plating resist on the panel substrate, the plating resist selectively exposing a portion of the substrate area and a portion of the dummy area to be plated.

8. The method according to claim 7, further comprising, prior to the stacking of the plating resist, forming a seed layer on the panel substrate.

9. The method according to claim 5, wherein in the determining of the ratio of the area being plated in the dummy area, the ratio of the area being plated in the dummy area is set to 95% with respect to the ratio of the area being plated in the substrate area.
